(19) United States
(12) Patent Application Publication
(10) Pub. No.: US 2002/0095346 A1
(43) Pub. Date: Jul. 18, 2002

(54) System for marketing real estate

(76) Inventor: Bennett J. Liss, Los Angeles, CA (US)

Correspondence Address: David A. Belasco, BEEHLER & PAVITT, Suite 330, 100 Corporate Pointe, Culver City, CA, 90230, US

(21) Appl. No.: 09/758,655

(22) Filed: Jan. 12, 2001

(51) Int. Cl. G06F 17/60

(52) U.S. Cl. 705/26

(57) ABSTRACT

A system for marketing real estate includes a venue, such as an open house, containing potentially interested and qualified real estate buyers controlled by a venue operator. A data gathering means, such as a computer terminal, controlled by a supplier of goods or services to the real estate industry or a promoter, permits the buyers to enter contact and real estate preference information into a database. The contact information includes the buyer's name, address, telephone and facsimile numbers, e-mail address and times to be reached. The real estate preference information includes the buyer's desired location, building size, lot size, number of rooms of a particular specification, climate control features, other building features, lot features and location features. The system yields customer contacts that result from information entered into the terminal. An agreement between the venue operator and the supplier or promoter provides for sharing revenues resulting from sales or rentals based on the information gathered. Software running on the computer terminal provides user-friendly instructions for real estate buyers to enter contact and preference information into the terminal. The information collected at the computer terminal in the venue may be relayed to a central location for addition to a master database. The master database provides means to track the origin of real estate contacts resulting from the collected information. The information entered into the database further includes responses to a contest displayed in connection with the data gathering means.

### FIELD OF INVENTION

The invention pertains to marketing systems. More particularly, the invention relates to automated systems for collaborative marketing of real estate properties.

### BACKGROUND OF THE INVENTION

Various systems have been developed for the identification of real properties matching customer requirements. U.S. Pat. No. 5,754,850 issued to Janssen is directed towards a real-estate method and apparatus for searching for homes in a search pool for exact and close matches according to primary and non-primary selection criteria. The kiosk search system has a touch monitor, a laser jet printer output portion and audio output portions. Using the system's selection screen for a home search, a user is asked what is the maximum price he or she is willing to pay for a potential home. The selection of maximum prices is displayed within rectangular borders of the screen.

U.S. Pat. No. 5,032,989 issued to Tornetta, is directed towards a real estate search and location system and method. The host system maintains a database of property listings submitted by those with properties to sell, lease or rent. The host system also maintains a set of client accounts. Each remote system is capable of interrogating the database by communicating a set of specifications for a desired property to be purchased to the host system. The specifications are derived from input buyer data. The host system either processes the search data on-line and returns a summary result or batches the interrogation requests for subsequent processing off-line.

U.S. Pat. No. 6,029,141, issued to Bezos et al is directed towards an Internet-based customer referral system. Special hyperlinks of the associate's catalog documents are provided in association with additional information that is transmitted to the merchant web site in response to the selection of the link. In one implementation, this information includes a unique identifier of the associate and a unique identifier of the selected product. A computer program of the merchant web site uses this information to identify the associate that was the source of the referral and to credit the sale to the associate if the customer subsequently purchases the product. Commission payments can then be paid to the associates on a periodic basis. Commission payments may be made electronically, via the computer program, without the need for involvement by the merchant.

U.S. Pat. No. 5,819,285 issued to Damico is directed towards an apparatus for capturing, storing and processing co-marketing information associated with a user of an on-line computer service using the World Wide Web. If the enrollment means determines that a user has been directed to the system from an authorized co-marketer, the enrollment means attempts to enroll the user in the system by assigning the user a unique user identification number and then asking the user to enter various personal information which is then stored in a subscriber information directory table on the enrollment database. The subscriber information directory table on the enrollment database is formed of a plurality of individual records, each of which contains several fields for storing information about a particular user.

While other variations exist, the above-described real estate marketing systems are typical of those encountered in the prior art. It is an objective of the present invention to provide a means of easily identifying qualified and motivated real estate buyers. It is a further objective to determine the purchase requirements for such buyers. It is a still further objective of the invention to provide an incentive for an owner wishing to sell his real estate to assist the user of the system to identify qualified buyers. It is yet a further objective to provide incentive for service vendors to absorb the cost of using and maintaining the system for the user.

While some of the objectives of the present invention are disclosed in the prior art, none of the inventions found include all of the requirements identified.

### SUMMARY OF THE INVENTION

The present invention addresses all of the deficiencies of prior art systems for marketing real estate and satisfies all of the objectives described above.

A system for marketing real estate may be created from the following components. A venue containing potentially interested and qualified real estate buyers is provided. The venue is controlled by a venue operator. A data gathering means permitting the buyers to enter information into a database is provided. The data gathering means is controlled by a supplier of goods or services to the real estate industry or by a promoter.

The information includes the buyer's contact information and real estate preference information. The contact information includes the buyer's name, address, telephone and facsimile numbers, e-mail address and times to be reached. The real estate preference information includes the buyer's desired location, building size, lot size, number of rooms of a particular specification, climate control features, other building features, lot features and location features.

The system yields customer contacts that result from information entered into the data gathering means by the buyers. An agreement is provided between the venue operator and the supplier of goods or services to the real estate industry or the promoter to share revenues resulting from sales, rentals or services provided based on the information gathered through the data gathering means.

In a variant of the invention, the venue containing potentially interested and qualified real estate buyers includes an open house. An open house is a real estate property held open for public viewing and offered for either of sale and lease.

In a further variant, the data gathering means further includes a computer terminal. The terminal includes a video screen, input means, non-volatile memory and a central processing unit. Data collection and organizing software running on the computer terminal is provided as is user-friendly instructions for real estate buyers to enter contact and preference information into the terminal. Means are provided for sorting and selecting potential buyers from the input information.

In still a further variant of the invention, the information collected at the computer terminal in the venue is relayed to a central location for addition to a master database. The master database provides means to track the origin of real estate contacts resulting from the collected information.

In yet another variant, the information entered into the database further includes responses to a contest displayed in connection with the data gathering means.

In a final variant of the invention, a vendor seeking to market services to the real estate agent sponsors the contest.

### DESCRIPTION OF THE DRAWINGS

FIG. 1 is a schematic perspective view of the preferred embodiment of the invention including an enlarged illustration of an open house with prospective buyers;

FIG. 2 is an illustration of agreements between a venue operator and a supplier of goods or services to the real estate industry or a promoter used in the FIG. 1 embodiment;

FIG. 3 is an illustration of a computer input screen image for buyer contact information used in the FIG. 1 embodiment;

FIG. 4 is an illustration of a computer input screen image for real estate preference information used in the FIG. 1 embodiment;

FIG. 5 is an illustration of a computer input screen image for contest questions used in the FIG. 1 embodiment; and

FIG. 6 is an illustration of a computer input screen image for real estate contact analysis used in the FIG. 1 embodiment.

### DETAILED DESCRIPTION OF THE PREFERRED EMBODIMENT

The present invention addresses many of the deficiencies of prior art systems for marketing real estate and satisfies all of the objectives described above.

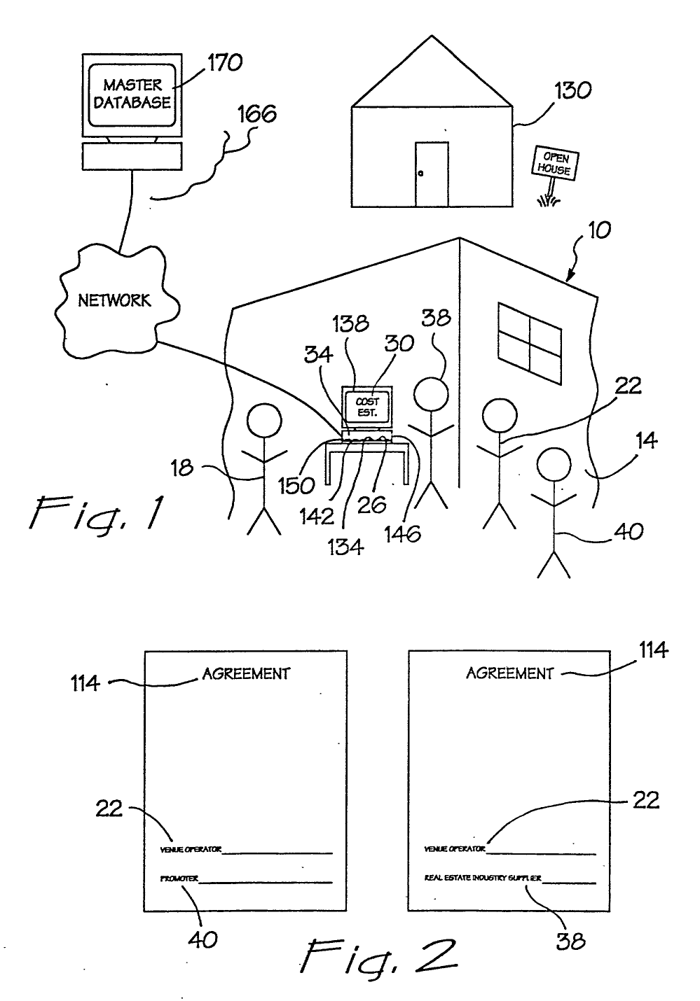

As illustrated in FIGS. 1-6, a system for marketing real estate 10 may be created from the following components. A venue 14 containing potentially interested and qualified real estate buyers 18 is provided. The venue 14 is controlled by a venue operator 22. A data gathering means 26 permitting the buyers 18 to enter information 30 into a database 34 is provided. The data gathering means 26 is controlled by a supplier of goods or services to the real estate industry 38 or by a promoter 40.

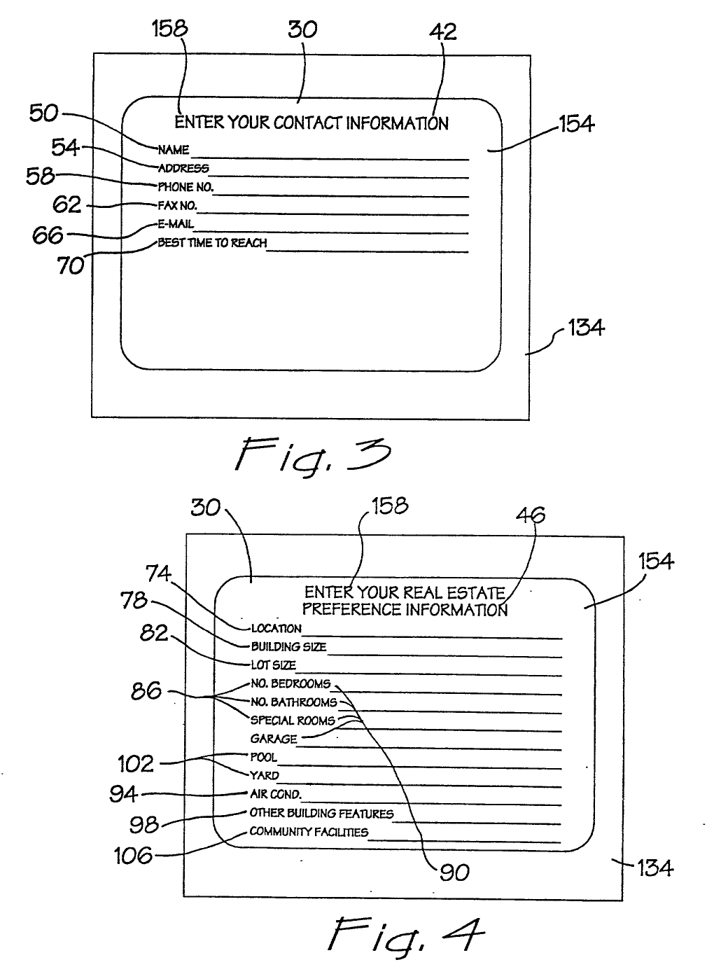

As illustrated in FIGS. 3 and 4, the information 30 includes the buyer's contact information 42 and real estate preference information 46. As shown in FIG. 3, the contact information 42 includes the buyer's name 50, address 54, telephone 58 and facsimile 62 numbers, e-mail address 66 and times to be reached 70. As shown in FIG. 4, the real estate preference information 46 includes the buyer's desired location 74, building size 78, lot size 82, number of rooms 86 of a particular specification 90, climate control features 94, other building features 98, lot features 102 and location features 106.

As illustrated in FIG. 6, the system 10 yields customer contacts 110 that result from information 30 entered into the data gathering means 26 by the buyers 18. As shown in FIG. 2, an agreement 114 is provided between the venue operator 22 and the supplier of goods or services to the real estate industry 38 or a promoter 40 to share revenues resulting from sales, rentals or services provided based on the information 30 gathered through the data gathering means 26.

In a variant of the invention, as illustrated in FIG. 1, the venue 14 containing potentially interested and qualified real estate buyers 18 includes an open house 130. An open house 130 is a real estate property held open for public viewing and offered for either of sale and lease.

In a further variant, the data gathering means 26 further includes a computer terminal 134. The terminal 134 includes a video screen 138, input means 142, non-volatile memory 146 and a central processing unit 150. As illustrated in FIGS. 3 and 4, data collection and organizing software 154 running on the computer terminal 134 is provided as is user-friendly instructions 158 for real estate buyers 18 to enter contact 42 and preference information 46 into the terminal 134. As illustrated in FIG. 6, means 162 are provided for sorting and selecting potential buyers 18 from the input information 30.

In still a further variant of the invention, as illustrated in FIG. 1, the information 30 collected at the computer terminal 134 in the venue 14 is relayed to a central location 166 for addition to a master database 170. As shown in FIG. 6, the master database 170 provides means to track the origin of real estate contacts 110 resulting from the collected information 30.

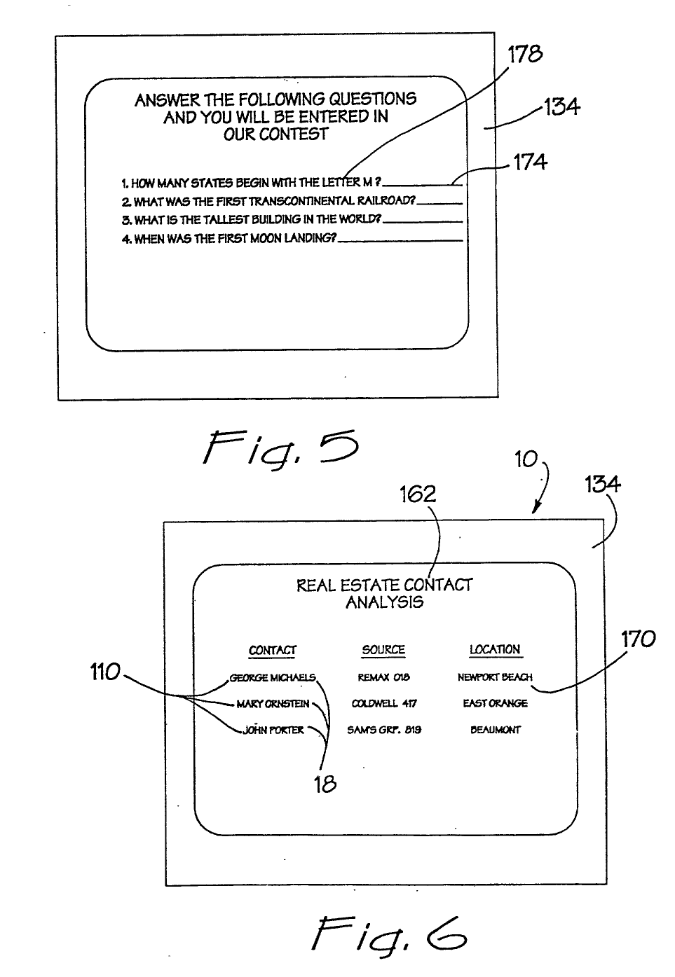

In a final variant, as illustrated in FIG. 5, the information entered into the database 34 further includes responses 174 to a contest 178 displayed in connection with the data gathering means 26.

1. A system for marketing real estate, comprising:
a venue containing potentially interested and qualified real estate buyers, said venue being controlled by a venue operator;
a data gathering means, said means permitting said buyers to enter information into a data base, said means being controlled by a supplier of either of goods and services to the real estate industry;
customer contacts, said contacts resulting from information entered into said data gathering means by said buyers; and
an agreement between the venue operator and the supplier of either of goods and services to the real estate industry to share revenues resulting from either of sales, rentals and services provided based on said data gathering.

2. A system for marketing real estate as described in claim 1 wherein the information entered into the data base comprises the buyer's contact information and real estate preference information.

3. A system for marketing real estate as described in claim 2 wherein the buyer's contact information comprises name, address, telephone and facsimile numbers, e-mail address and times to be reached.

4. A system for marketing real estate as described in claim 2 wherein the real estate preference information comprises the buyer's desired location, building size, lot size, number of rooms of a particular specification, climate control features, other building features, lot features and location features.

5. A system for marketing real estate as described in claim 1 wherein the venue containing potentially interested and qualified real estate buyers further comprises:
an open house, said open house being a real estate property held open for public viewing and offered for either of sale and lease.

6. A system for marketing real estate as described in claim 1 wherein said data gathering means further comprises:
a computer terminal, said terminal including a video screen, input means, non-volatile memory and central processing unit;
data collection and organizing software running on said computer terminal;
user-friendly instructions for real estate buyers to enter contact and preference information; and
means for sorting and selecting and potential buyers from said input information.

7. A system for marketing real estate as described in claim 6 wherein the data collected at the computer terminal in the venue is relayed to a central location for addition to a master data base, said master data base providing means to track the origin of real estate contacts resulting from said collected information.

8. A system for marketing real estate as described in claim 1 wherein the information entered into the database further includes responses to a contest displayed in connection with the data gathering means.

9. A system for marketing real estate, comprising:
a venue containing potentially interested and qualified real estate buyers, said venue being controlled by a venue operator;
a data gathering means, said means permitting said buyers to enter information into a data base, said means being controlled by a promoter;
customer contacts, said contacts resulting from information entered into said data gathering means by said buyers; and
an agreement between the venue operator and the promoter to share revenues resulting from either of sales, rentals and services provided based on said data gathering.

10. A system for marketing real estate as described in claim 9 wherein the information entered into the data base comprises the buyer's contact information and real estate preference information.

11. A system for marketing real estate as described in claim 10 wherein the buyer's contact information comprises name, address, telephone and facsimile numbers, e-mail address and times to be reached.

12. A system for marketing real estate as described in claim 10 wherein the real estate preference information comprises the buyer's desired location, building size, lot size, number of rooms of a particular specification, climate control features, other building features, lot features and location features.

13. A system for marketing real estate as described in claim 9 wherein the venue containing potentially interested and qualified real estate buyers further comprises:
an open house, said open house being a real estate property held open for public viewing and offered for either of sale and lease.

14. A system for marketing real estate as described in claim 9 wherein said data gathering means further comprises:
a computer terminal, said terminal including a video screen, input means, non-volatile memory and central processing unit;
data collection and organizing software running on said computer terminal;
user-friendly instructions for real estate buyers to enter contact and preference information; and
means for sorting and selecting and potential buyers from said input information.

15. A system for marketing real estate as described in claim 14 wherein the data collected at the computer terminal in the venue is relayed to a central location for addition to a master data base, said master data base providing means to track the origin of real estate contacts resulting from said collected information.

16. A system for marketing real estate as described in claim 9 wherein the information entered into the database further includes responses to a contest displayed in connection with the data gathering means.
